(19) United States
(12) Patent Application Publication
(10) Pub. No.: US 2022/0301415 A1
(43) Pub. Date: Sep. 22, 2022

(54) Shoelace Tracking Assembly

(71) Applicant: Jesse Reynolds, Indianapolis, IN (US)

(72) Inventor: Jesse Reynolds, Indianapolis, IN (US)

(21) Appl. No.: 17/203,825

(22) Filed: Mar. 17, 2021

(51) Int. Cl. G08B 25/01; A43C 9/02; A43B 3/00

(52) U.S. Cl. CPC G08B 25/016; A43C 9/02; A43B 3/0005

(57) ABSTRACT

A shoelace tracking assembly includes a belt that can be worn around a person's waist. A bracelet is provided that can be worn on a person's wrist. A shoe lace is provided that can be laced into a shoe. A personal electronic device is provided that is in wireless communication with an extrinsic communication network. A plurality of tracking units is each attachable to a respective one of the shoe lace, the belt and the bracelet. Each of the tracking units is in wireless communication with a global positioning system to determine the physical location of the shoe lace, the belt and the bracelet. Moreover, each of the tracking units is in wireless communication with the personal electronic device to facilitate a caregiver to track the location of the person wearing the shoe, the belt or the bracelet.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tracking device and more particularly pertains to a new tracking device to facilitate a caregiver to track the location of a person the caregiver is caring for. The device includes a plurality of tracking units that is each integrated into a respective shoe lace, belt or bracelet. Each of the tracking units is in communication with a personal electronic device that is carried by the caregiver.

### (2) Description of Related Art Including Information Disclosed Under 37 CFR 1.97 and 1.98

The prior art relates to tracking device including a variety of tracking devices that are integrated into a bracelet for tracking an individual. The prior art also discloses a variety of tracking devices that are each integrated into a shoe lace for tracking a person that is wearing a shoe in which the shoe lace is laced. In no instance does the prior art disclose a tracking device that includes a plurality of tracking units each being integrated into a respective shoe lace, belt and bracelet.

### BRIEF SUMMARY OF THE INVENTION

An embodiment of the disclosure meets the needs presented above by generally comprising a belt that can be worn around a person's waist. A bracelet is provided that can be worn on a person's wrist. A shoe lace is provided that can be laced into a shoe. A personal electronic device is provided that is in wireless communication with an extrinsic communication network. A plurality of tracking units is each attachable to a respective one of the shoe lace, the belt and the bracelet. Each of the tracking units is in wireless communication with a global positioning system to determine the physical location of the shoe lace, the belt and the bracelet. Moreover, each of the tracking units is in wireless communication with the personal electronic device to facilitate a caregiver to track the location of the person wearing the shoe, the belt or the bracelet.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a shoelace tracking assembly according to an embodiment of the disclosure.

FIG. 2 is a top view of an embodiment of the disclosure showing a tracking unit integrated onto a shoe lace.

FIG. 3 is a top view of an embodiment of the disclosure showing a tracking unit integrated into a belt.

FIG. 4 is a front view of an embodiment of the disclosure showing a tracking unit integrated into a bracelet.

FIG. 5 is a schematic view of an embodiment of the disclosure.

### DETAILED DESCRIPTION OF THE INVENTION

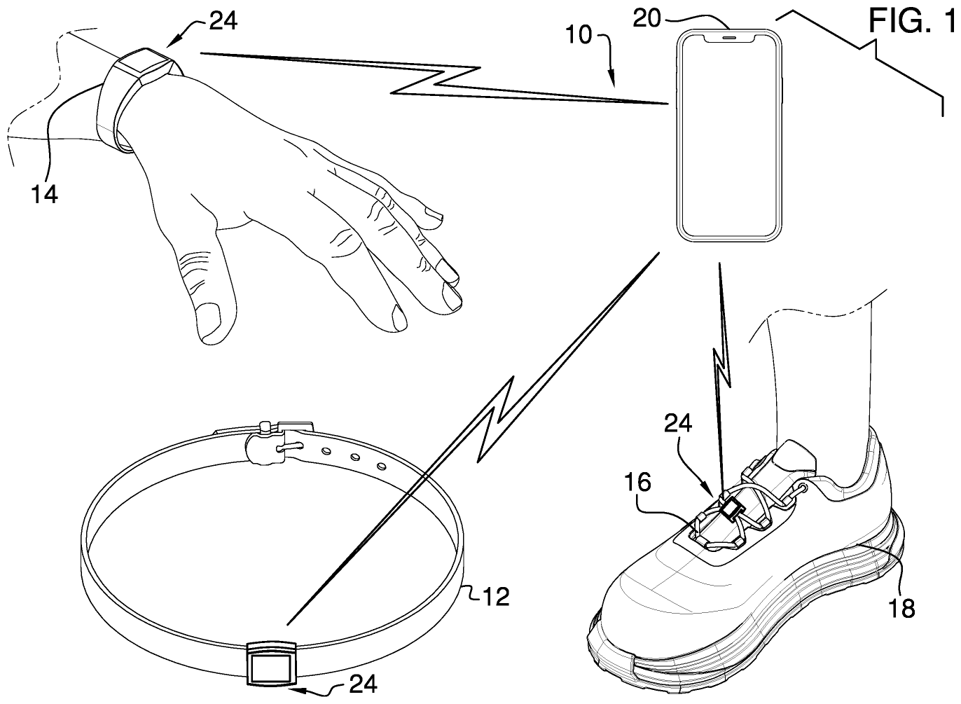

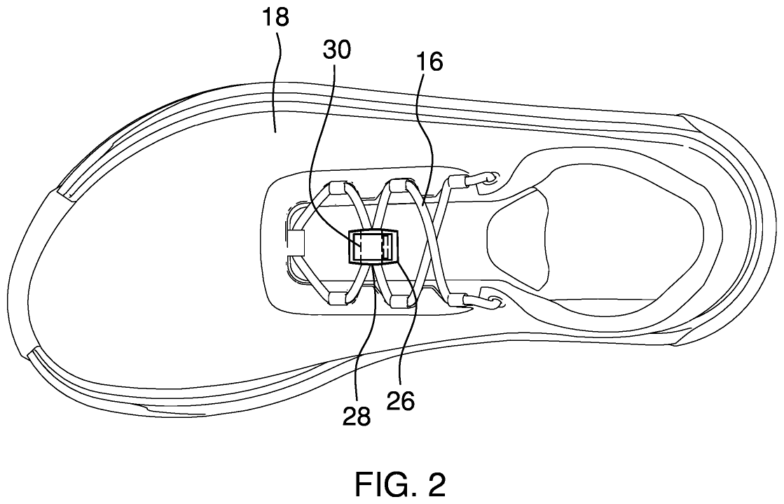

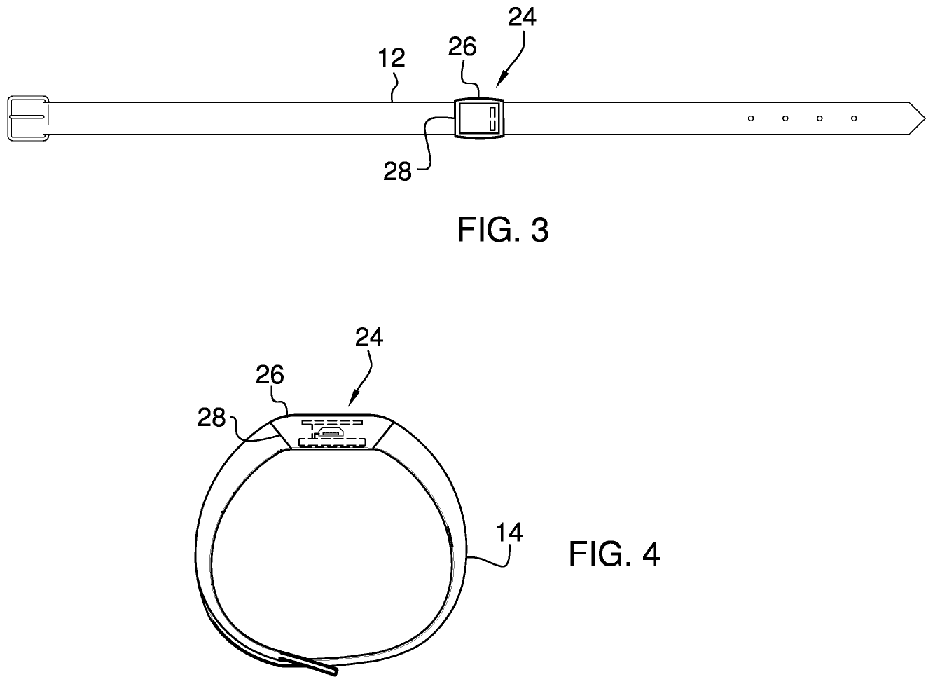

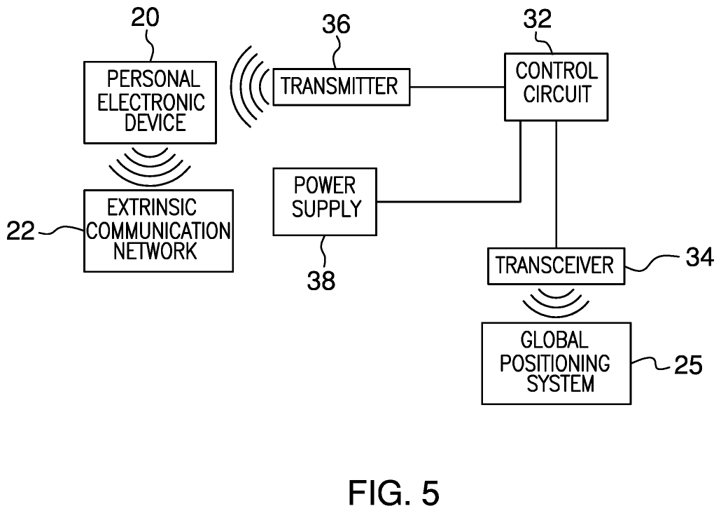

With reference now to the drawings, and in particular to FIGS. 1 through 5 thereof, a new tracking device embodying the principles and concepts of an embodiment of the disclosure and generally designated by the reference numeral 10 will be described.

As best illustrated in FIGS. 1 through 5, the shoelace tracking assembly 10 generally comprises a belt 12 that can be worn around a person's waist, a bracelet 14 that can be worn on a person's wrist and a shoe lace 16 that can be laced into a shoe 18. The belt 12 may be an apparel belt of any conventional design and the bracelet 14 may be a bracelet of any conventional design. A personal electronic device 20 is provided and the personal electronic device 20 is in wireless communication with an extrinsic communication network 22. The personal electronic device 20 may comprise a smart phone or other similar type of device and the extrinsic communication network 22 may comprise a cellular phone network, the internet or other wireless communication network.

A plurality of tracking units 24 is each of attachable to a respective one of the shoe lace 16, the belt 12 and the bracelet 14. Each of the tracking units 24 is in wireless communication with a global positioning system 25 to determine the physical location of the shoe lace 16, the belt 12 and the bracelet 14. Moreover, each of the tracking units 24 is in wireless communication with the personal electronic device 20 thereby facilitating the personal electronic device 20 to receive the physical location of each of the tracking units 24. In this way the personal electronic device 20 facilitates a caregiver to track the location of the person wearing the shoe. The person wearing the shoe 18, bracelet 14 or belt 12 may be a child or a developmentally disabled adult that requires supervision and the caregiver may be a person that is charged with the care of the person wearing the shoe 18, bracelet 14 or belt 12.

Each of the tracking units 24 comprises a housing 26 that has an outer wall 28. The outer wall 28 of the housing 26 that is associated with the shoe lace 16 has a tunnel 30 extending therethrough thereby facilitating the shoe lace 16 to be extended through the tunnel 30. The outer wall 28 of the housing 26 associated with the belt 12 is integrated into the belt 12. Additionally, the outer wall 28 of the housing 26 associated with the bracelet 14 is integrated into the bracelet 14.

Each of the tracking units 24 includes a control circuit 32 that is positioned in the housing 26. Each of the tracking units 24 includes a transceiver 34 that is positioned in the housing 26. The transceiver 34 is electrically coupled to the control circuit 32 and the transceiver 34 is in wireless communication with the global positioning system 25. The transceiver 34 may comprise a radio frequency transceiver or the like.

Each of the tracking units 24 includes a transmitter 36 that is positioned in the housing 26. The transmitter 36 is electrically coupled to the control circuit 32 and the transmitter 36 broadcasts a location signal. The transmitter 36 is in wireless communication with the personal electronic device 20 such that the personal electronic device 20 receives the location signal. In this way the personal electronic device 20 can display the location of the person to the caregiver. The transmitter 36 may comprise a radio frequency transmitter or the like and the transmitter 36 may employ Bluetooth communication protocols. The personal electronic device 20 may store global positioning software that facilitates the physical location of the tracking unit to be displayed on a map or the like. Each of the tracking units 24 includes a power supply 38 that is positioned in the housing 26, the power supply 38 is electrically coupled to the control circuit 32 and the power supply 38 comprises at least one battery.

In use, either the belt 12, the bracelet 14 or the shoe 18 that is laced with the shoe lace 16 is worn by the person that the caregiver is charged with monitoring, depending on the preference of the caregiver. The transmitter 36 in the tracking unit 24 is synched with the personal electronic device 20. In this way the personal electronic device 20 can display the physical location of the person such that the caregiver can continuously monitor the location of the person.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A shoelace tracking assembly for tracking the location of a person, said assembly comprising:
a belt being configured to be worn around a person's waist;
a bracelet being configured to be worn on a person's wrist;
a shoe lace being configured to be laced into a shoe;
a personal electronic device being in wireless communication with an extrinsic communication network;
a plurality of tracking units, each of said tracking units being attachable to a respective one of said shoe lace, said belt and said bracelet, each of said tracking units being in wireless communication with a global positioning system wherein each said tracking unit is configured to determine the physical location of said shoe lace, said belt and said bracelet, each of said tracking units being in wireless communication with said personal electronic device thereby facilitating said personal electronic device to receive the physical location of each of said tracking units wherein said personal electronic device is configured to facilitate a caregiver to track the location of the person wearing the shoe, said belt or said bracelet;
wherein each of said tracking units comprises a housing having an outer wall;
wherein said outer wall of said housing associated with said shoe lace has a tunnel extending therethrough thereby facilitating said shoe lace to be extended through said tunnel whereby said housing associated with said shoe lace is exposed on said shoe lace and configured to be visible on said shoe lace;
wherein said outer wall of said housing associated with said belt is integrated into said belt; and
wherein said outer wall of said housing associated with said bracelet is integrated into said bracelet.

2. (canceled)

3. The assembly according to claim 1, wherein each of said tracking units includes:
a control circuit being positioned in said housing; and
a transceiver being positioned in said housing, said transceiver being electrically coupled to said control circuit, said transceiver being in wireless communication with the global positioning system.

4. The assembly according to claim 3, wherein each of said tracking units includes a transmitter being positioned in said housing, said transmitter being electrically coupled to said control circuit, said transmitter broadcasting a location signal, said transmitter being in wireless communication with said personal electronic device such that said personal electronic device receives said location signal wherein said personal electronic device is configured to display the location of the person to the caregiver.

5. A shoelace tracking assembly for tracking the location of a person, said assembly comprising:
a belt being configured to be worn around a person's waist;
a bracelet being configured to be worn on a person's wrist;
a shoe lace being configured to be laced into a shoe;
a personal electronic device being in wireless communication with an extrinsic communication network; and
a plurality of tracking units, each of said tracking units being attachable to a respective one of said shoe lace, said belt and said bracelet, each of said tracking units being in wireless communication with a global positioning system wherein each said tracking unit is configured to determine the physical location of said shoe lace, said belt and said bracelet, each of said tracking units being in wireless communication with said personal electronic device thereby facilitating said personal electronic device to receive the physical location of each of said tracking units wherein said personal electronic device is configured to facilitate a caregiver to track the location of the person wearing the shoe, said belt or said bracelet, each of said tracking units comprising:
a housing having an outer wall, said outer wall of said housing being associated with said shoe lace having a tunnel extending therethrough thereby facilitating said shoe lace to be extended through said tunnel whereby said housing associated with said shoe lace is exposed on said shoe lace and configured to be visible on said shoe lace, said outer wall of said housing being associated with said belt being integrated into said belt, said outer wall of said housing associated with said bracelet being integrated into said bracelet;
a control circuit being positioned in said housing;
a transceiver being positioned in said housing, said transceiver being electrically coupled to said control circuit, said transceiver being in wireless communication with the global positioning system;
a transmitter being positioned in said housing, said transmitter being electrically coupled to said control circuit, said transmitter broadcasting a location signal, said transmitter being in wireless communication with said personal electronic device such that said personal electronic device receives said location signal wherein said personal electronic device is configured to display the location of the person to the caregiver; and
a power supply being positioned in said housing, said power supply being electrically coupled to said control circuit, said power supply comprising at least one battery.
